(19) United States
(12) Patent Application Publication
(10) Pub. No.: US 2016/0278574 A1
(43) Pub. Date: Sep. 29, 2016

(54) DETACHABLE FOOD GRIDDLE

(71) Applicant: HAIYAN XINHUA ELECTRIC APPLIANCE CO., LTD, Haiyan Zhejiang (CN)

(72) Inventor: Jianxin Ren, Haiyan (CN)

(21) Appl. No.: 15/035,363

(22) PCT Filed: Nov. 15, 2013
(86) PCT No.: PCT/IB2013/002564

§ 371 Date: May 9, 2016

(51) Int. Cl. A47J 37/06

(52) U.S. Cl. CPC A47J 37/0611

(57) ABSTRACT

A detachable food griddle structure. A bottom heating plate is affixed to a base. A cover is rotatably coupled to a shaft that is mounted on the base, and a top heating plate is affixed to the underside of the cover. A bottom ring is removably coupled to the shaft above the heating plate, and a top ring is removably coupled to the base above the bottom ring. A cooking plate is removably coupled to an underside of the top ring.

### CROSS-REFERENCE

This is a United States National Phase of PCT/IB2013/002564 filed Nov. 15, 2013, the entire disclosure of which is incorporated herein by reference.

### TECHNICAL FIELD

This disclosure relates generally to the field of food heating appliances, and more particularly, to a press-type griddle or sandwich machine for heating sandwiches and the like which is easy to quickly disassemble for cleaning.

### BACKGROUND

A conventional press-type sandwich machine has two heating surfaces that oppose each other in a hinged relationship. Typically, one or more sandwiches or other food items, such as panini, quesadilla, hamburger, etc., are placed onto the bottom heating surface, and the top surface is lowered onto the food item to heat or cook the food item between the heating surfaces.

However, these press-type sandwich machines are difficult to clean after use because many of the parts cannot be fully disassembled from the machine. Thus, the machine often does not get cleaned very well. In addition, the parts are usually not dishwasher safe materials, or at least not recommended for the dishwasher.

### BRIEF DESCRIPTION OF THE DRAWINGS

FIG. 1 is a front perspective view of a detachable food griddle.

FIG. 2 is a side plan view of the detachable food griddle of FIG. 1 with the cover open.

FIG. 3 is a rear plan view of the detachable food griddle of FIG. 1.

FIG. 4 is a perspective view of a shaft having a flat recessed area.

FIG. 5 is a top perspective view of a top removable ring.

FIG. 6 is a side plan view of the detachable food griddle of FIG. 1, similar to FIG. 2, with the cover open and the top ring removed.

FIG. 7 is a top plan view of a cooking plate juxtaposed with the top ring of FIG. 5.

FIG. 8A is a side plan view of the cooking place interposed between the top ring and a bottom ring.

FIG. 8B is a side plan view showing the enlarged detail 8B of FIG. 8A.

FIG. 8C is an exploded perspective view showing the components of a fastener that connects the top ring, the cooking plate, and the bottom ring.

FIG. 9 is a top perspective view of the bottom removable ring.

FIG. 10 is a side plan view of the detachable food griddle of FIG. 1, similar to FIG. 6, with the cover open and the bottom ring removed.

### DETAILED DESCRIPTION

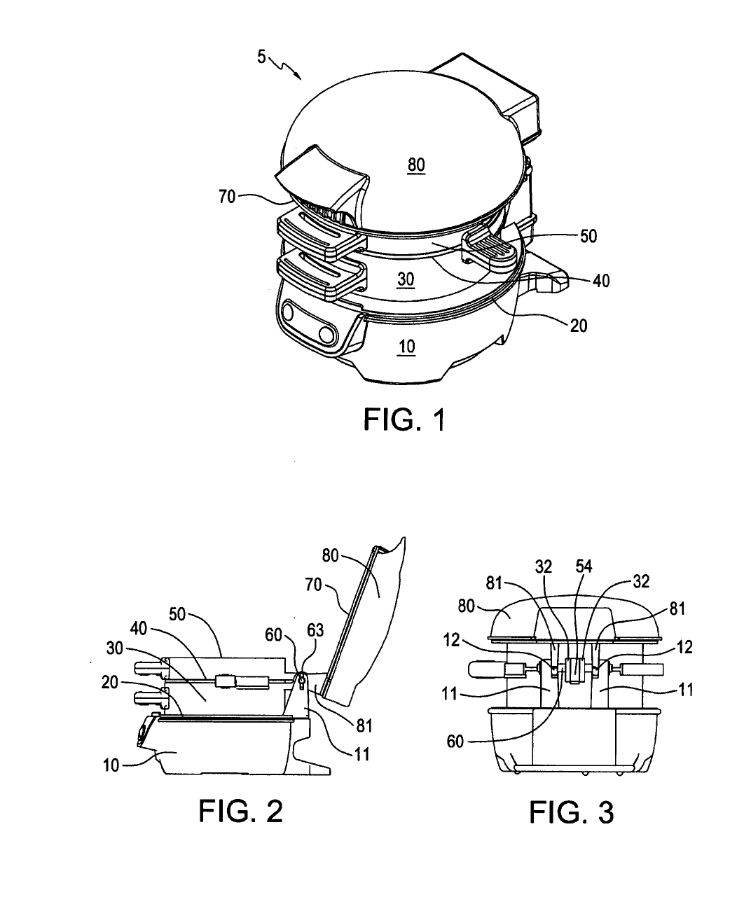

This disclosure describes a press-type griddle or sandwich machine that is easy to disassemble for cleaning. FIG. 1 illustrates a sandwich machine 5 in a fully assembled state with its cover 80 closed. In FIG. 2, the sandwich machine 5 is shown with its cover 80 open. FIG. 3 is a rear view of the sandwich machine 5 that better illustrates the rotating coupling between the cover 80 and the base 10.

The sandwich machine 5 include a base 10, a bottom heating plate 20 affixed to the base, a bottom ring 30 removably coupled to the base, a top ring 50 removably coupled to the base, a cooking plate 40 removably coupled to the underside of the top ring, and a top heating plate 70 affixed to the cover 80. The heating plates 20, 70 and rings 30, 50 may be made from anodized aluminum or other suitable materials, and the cooking plate 40 may be made from Teflon® coated aluminum or other suitable materials. The base 10 and cover 80 may be made from a combination of rigid plastic materials for the structure and soft plastic materials for the shell.

As best seen in FIG. 3, the base 10 includes a pair of base posts 11 that are rigidly affixed to the base and symmetrically disposed to stand upright at the back of the base. Likewise, the cover 80 includes a corresponding pair of cover posts 81 that are rigidly affixed to the cover and symmetrically disposed to extend downward from the back of the cover and align with the base posts for a rotatable coupling with a shaft 60. In one embodiment, a notch 12 is formed on the inside portion of each base post 11, and the cover posts 81 are fit within the notches. The shaft 60 is fitted through corresponding openings formed in each the posts 11, 81 to provide a horizontal line of rotation about which the cover 80 is opened and closed. Advantageously, the shaft 60 also provides a connection point for removable coupling of the top ring 50 and the bottom ring 30, as further described below.

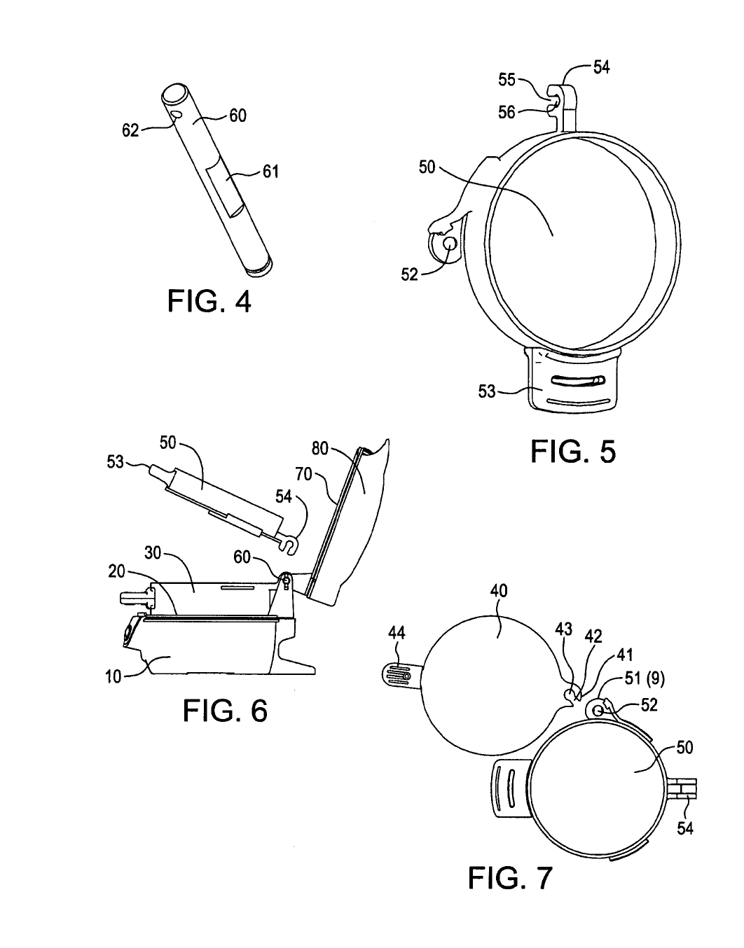

One embodiment of the shaft 60 is illustrated in FIG. 4, which shows a cylindrical structure formed of cold-rolled steel or other suitable material with a recessed flat portion 61 formed on one side and a through hole 62 for receiving a locking pin 63 (see FIG. 2) formed on one end. To facilitate the removable coupling of the top ring 50 and the bottom ring 30, the shaft 60 must be fixed in position so that the flat portion is able to cooperate with corresponding portions of the top ring and bottom ring for easy removal and re-assembly, as will now be described.

One embodiment of a generally cylindrical top ring 50 is shown in FIG. 5, which includes a tab portion 51 formed to extend in a horizontal plane from one side of the cylinder, with a connection hole 52 formed in the center of the tab; a handle portion 53 formed to extend from the front of the cylinder; and a slotted ear portion 54 extending from the bottom of the back of the cylinder. The tab 51 is offset below top ring cylinder 50 for mating with the cooking plate 40 as described below. The slotted ear 54 is a single post extending straight back from the single point on the top ring cylinder 50 that lies in the tangent line that is parallel to the shaft 60, then terminating in a downward facing slot 55 having a circular opening 56 at the end of the slot that is slightly larger than the slot. The downward facing slot enables removable coupling with the flat recessed portion 61 of the shaft 60.

FIG. 6 shows removal of the top ring 50 from the sandwich machine 5. With the cover 80 open, grasp the front handle 53 of the top ring 50 and lift the ring upward so that it rotates backward about the shaft 60 until the slot ear 54 aligns with the flat portion 61 of shaft 60. The top ring 50 is then lifted up and off while the slot ear 54 is aligned with the flat portion 61. In one embodiment, the slot ear 54 and flat portion 61 oriented so that alignment for removal occurs at an acute angle of approximately 30 to 60 degrees. Conversely, the top ring 50 is installed by holding it at a slight upward angle such that the slot ear 54 is aligned with the flat portion 61 of shaft 60, then sliding the slot ear down over the shaft to the end of the slot 55 and rotating the ring downward to a closed position.

As noted above, the cooking plate 40 is removably coupled with the top ring 50. One embodiment of the cooking plate 40 is illustrated in FIG. 7 in juxtaposition with the top ring 50. The cooking plate 40 is generally circular and flat and includes a tab portion 41 formed to extend from the rear of the cooking plate and mate with the tab portion 51 on the side of the top ring 50. The tab portion 41 includes a slot 42 and an enlarged connection hole 43 in the center of the slot, i.e., the diameter of the connection hole 43 is a little bigger than the width of the slot 42.

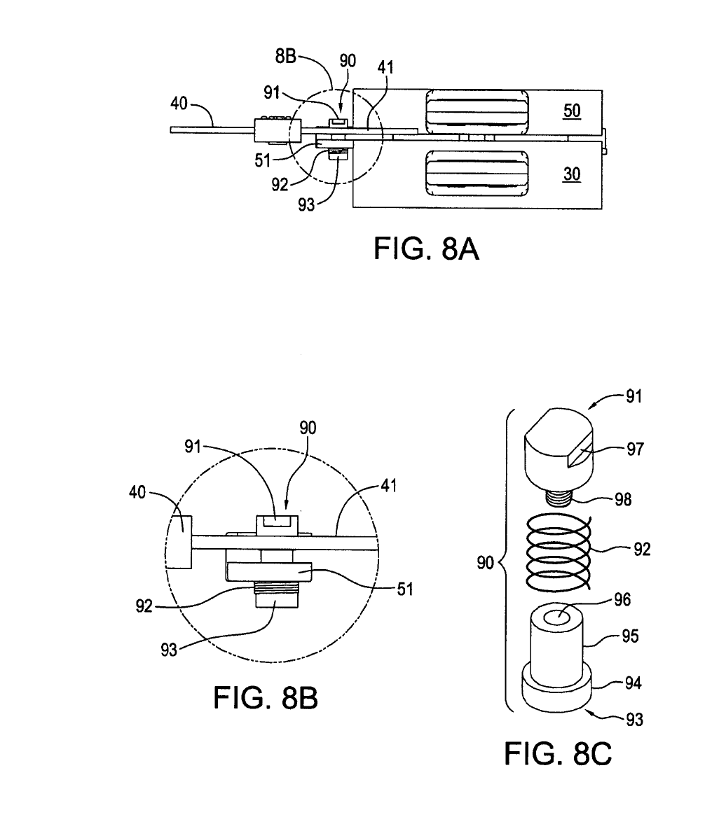

A fastener 90 is installed through connection hole 52 in the top ring 50, and in a preferred embodiment, the fastener includes a location pin 91, a spring 92 and a connection shaft 93, as shown in FIGS. 8A, 8B and 8C. The connection shaft 93 includes a head portion 94 and a smaller diameter neck portion 95 having interior threads 96. The location pin 91 includes a head portion 97 and a smaller diameter neck portion 98 that is threaded to mate with the threads 96 of the connection shaft. The diameter of the head portion 97 of the location pin 91 is larger than the diameter of the neck portion 95 of the connection shaft 93. The spring 92 is fitted over the neck portion 95 of the connection shaft 93 and butted against the head portion 94, then the connection shaft with spring is inserted from the bottom through connection hole 52 of the top ring 50, and secured in place by threading the location pin 91 onto the connection shaft. The connection shaft 93 is sized to enable sliding it up and down though the connection hole 52.

To install the cooking plate 40 onto the top ring 50, the connection shaft 93 is pushed upward in connection hole 52 against the resistance of the spring 92, which exposes the neck portion 95 of the connection shaft above the tab 51 of the top ring. The slot 42 of the tab portion 41 on the cooking plate 40 is then pushed all the way onto the neck portion, and the pressure against the connection shaft 93 is released causing the location pin 91 to be dropped into the connection 43 hole of the slot and secure the cooking plate. The cooking plate 40 is then rotated into an assembled position coaxial with the top ring 50. To disassemble, the connection shaft 93 is pushed upward and the cooking plate 40 is rotated outward and removed.

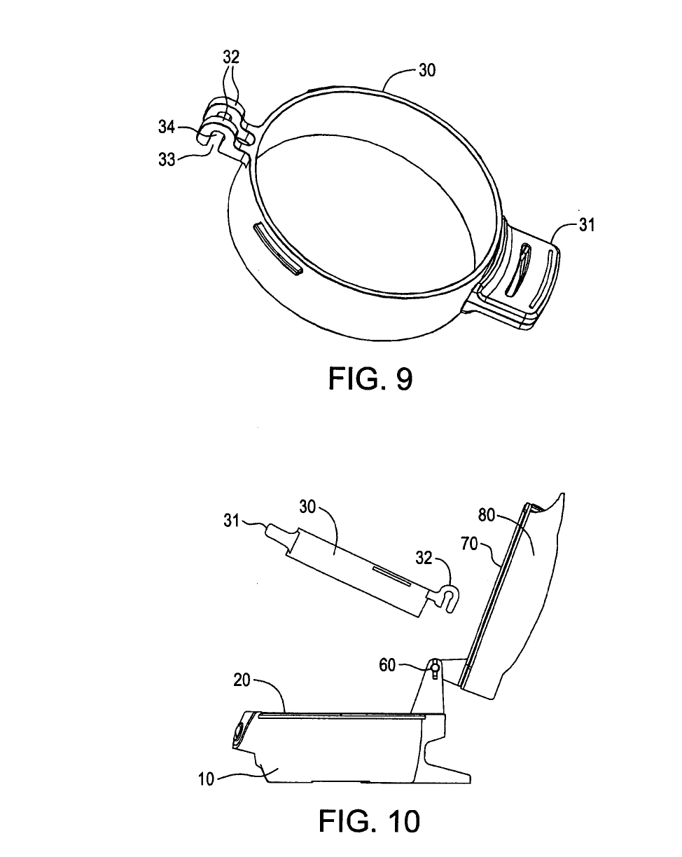

One embodiment of a generally cylindrical bottom ring 30 is shown in FIG. 9, which includes a handle portion 31 formed to extend from the front of the cylinder; and a slotted ear portion 32 extending from the back of the cylinder. The slotted ear 32 is a pair of posts extending straight back from the top of the bottom ring 30, like the slot ear 54 of the top ring 50, and terminating in a pair of downward facing slots 33 having circular openings 34 at the end of the slots that are slightly larger than the slots. The downward facing slots 33 enable removable coupling with the flat recessed portion 61 of the shaft 60.

FIG. 10 shows removal of the bottom ring 30 from the sandwich machine 5. With the cover 80 open, and the top ring 50 already removed, grasp the front handle 31 of the bottom ring 30 and lift the ring upward so that it rotates backward about the shaft 60 until the slot ears 32 are aligned with the flat portion 61 of shaft 60. The bottom ring 30 is then lifted up and off while the slot ears 32 are aligned with the flat portion 61. In one embodiment, the slot ears 32 and flat portion 61 are oriented so that alignment for removal occurs at an acute angle of approximately 30 to 60 degrees. Conversely, the bottom ring 30 is installed by holding it at a slight upward angle such that the slot ears 32 are aligned with the flat portion 61 of shaft 60, then sliding the slot ears down over the flat portion 61 of shaft 60 to the end of the slots, and rotating the ring downward to a closed position.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

1. A food heating appliance, comprising:
a base;
a bottom heating plate affixed to the base;
a bottom ring removably coupled to the base above the heating plate;
a top ring removably coupled to the base above the bottom ring;
a cooking plate removably coupled to an underside of the top ring;
a cover rotatably affixed to the base; and
a top heating plate affixed to an underside of the cover.

2. The food heating appliance of claim 1, further comprising:
a first set of two upright posts symmetrically positioned apart from each other on the base and extending upward from a rear portion of the base, the posts having corresponding openings therein;
a second set of two upright posts symmetrically positioned apart from each other on the cover and extending downward from a rear portion of the cover, the posts having corresponding openings therein, wherein the second set of posts are set apart less than the first set of posts in order to fit within the first set of posts; and
a shaft fixed through the openings of the first and second sets of posts, wherein the top ring, the bottom ring are removably coupled to the shaft.

3. The food heating appliance of claim 2, the shaft further comprising:
a cylindrical shaft having a diameter and a flat portion formed as a recess on a central portion of the shaft, the flat portion being narrower in width than the diameter of the shaft, wherein the top ring and the bottom ring are removably coupled to the shaft at its flat portion.

4. The food heating appliance of claim 3, further comprising:
at least one tab with a slot, the slotted tab formed to extend from each of the top ring and the bottom ring, wherein the slotted tab fits over the flat portion of the shaft.

5. The food heating appliance of claim 4, each slotted tab further comprising:
a circular hole formed at an end of the slot, wherein the width of the slot is smaller than a diameter of the circular hole, the diameter of the circular hole being substantially the same as the diameter of the cylindrical shaft.

6. The food heating appliance of claim 1, further comprising:
the top ring is a cylindrical ring with a first tab extending from one side thereof;
the cooking plate is a circular plate with second tab extending from one side thereof in correspondence with the first tab extending from the top ring; and
a fastener coupling the second tab on the cooking plate with the first tab on the top ring.

7. The food heating appliance of claim 6, further comprising:
the first tab of the top ring having a first connection hole, wherein the fastener is fixed in the first connection hole; and
the second tab of the cooking plate having a slot with a second connection hole, the slot configured to slides onto the fastener when it is fixed in the first connection hole.

8. The food heating appliance of claim 7, the fastener further comprising:
a connection shaft having a head and a neck, the neck having a smaller diameter than the head and a set of internal threads formed inside the neck;
a spring fitted over the neck of the connection shaft to abut the head of the connection shaft; and
a locating pin having a head and a neck, the neck having a set of external threads that mate with the internal threads of the connection shaft;
wherein the connection shaft and spring are inserted from below through the first connection hole of the first tab of the top ring, and the threads of the locating pin are coupled with the threads of the connection shaft, and
wherein the connection shaft is pushed upward against a force of the spring to expose the neck of the connection shaft above the first tab of the top ring, the slot of the second tab of the cooking plate is slid onto the exposed neck, then the connection shaft is released and returned downward by the spring force so that the locating pin drops into the second connection hole of the second tab of the cooking plate.

9. The food heating appliance of claim 5, further comprising:
a single tab extending from a bottom portion of the top ring and having a slot; and
a pair of tabs extending from a top portion of the bottom ring, each tab having a slot;
wherein the slotted pair of tabs fit over the flat portion of the shaft, and the slotted single tab fits between the slotted pair of tabs over the flat portion of the shaft.

10. The food heating appliance of claim 9, wherein:
the slotted single tab slides over the flat portion of the shaft and the bottom ring is rotated into a closed position; and
the slotted pair of tabs slide over the flat portion of the shaft and the top ring is rotated into a closed position.

11. A food heating appliance, comprising:
a base having a first pair of upright posts symmetrically positioned apart from each other and extending upward from a rear portion of the base, the posts having corresponding openings therein;
a bottom heating plate affixed to the base;
a cover having a second pair of upright posts symmetrically positioned apart from each other and extending downward from a rear portion of the cover, the posts having corresponding openings therein, wherein the second set of posts are set apart less than the first set of posts in order to fit within the first set of posts;
a top heating plate affixed to an underside of the cover;
a shaft fixed through the openings of the first and second pairs of posts, wherein the cover and affixed heating plate are rotatable about the shaft;
a bottom ring having a pair of tabs extending from a top portion thereof, each tab having a slot, wherein the pair of slots are removably coupled to the shaft;
a top ring having a single tab extending from a bottom portion thereof, the tab having a slot, wherein the single slot is removably coupled to the shaft; and
a cooking plate removably coupled to an underside of the top ring.

12. The food heating appliance of claim 11, the shaft further comprising:
a cylindrical shaft having a diameter and a flat portion formed as a recess on a central portion of the shaft, the flat portion being narrower in width than the diameter of the shaft, wherein the top ring and the bottom ring are removably coupled to the shaft at its flat portion.

13. The food heating appliance of claim 12, further comprising:
a circular hole formed at an end of each slot in the single tab and the pair of tabs, wherein the width of the slot is smaller than a diameter of the circular hole, the diameter of the circular hole being substantially the same as the diameter of the cylindrical shaft.

14. The food heating appliance of claim 11, further comprising:
the top ring is a cylindrical ring with a first tab extending from one side thereof;
the cooking plate is a circular plate with second tab extending from one side thereof in correspondence with the first tab extending from the top ring; and
a fastener coupling the second tab on the cooking plate with the first tab on the top ring.

15. The food heating appliance of claim 14, further comprising:
the first tab of the top ring having a first connection hole, wherein the fastener is fixed in the first connection hole; and
the second tab of the cooking plate having a slot with a second connection hole, the slot configured to slides onto the fastener when it is fixed in the first connection hole.

16. The food heating appliance of claim 15, the fastener further comprising:
a connection shaft having a head and a neck, the neck having a smaller diameter than the head and a set of internal threads formed inside the neck;
a spring fitted over the neck of the connection shaft to abut the head of the connection shaft; and
a locating pin having a head and a neck, the neck having a set of external threads that mate with the internal threads of the connection shaft;
wherein the connection shaft and spring are inserted from below through the first connection hole of the first tab of the top ring, and the threads of the locating pin are coupled with the threads of the connection shaft, and
wherein the connection shaft is pushed upward against a force of the spring to expose the neck of the connection shaft above the first tab of the top ring, the slot of the second tab of the cooking plate is slid onto the exposed neck, then the connection shaft is released and returned downward by the spring force so that the locating pin drops into the second connection hole of the second tab of the cooking plate.

17. A food heating appliance, comprising:
a base having a first pair of upright posts symmetrically positioned apart from each other and extending upward from a rear portion of the base, the posts having corresponding openings therein;
a bottom heating plate affixed to the base;
a cover having a second pair of upright posts symmetrically positioned apart from each other and extending downward from a rear portion of the cover, the posts having corresponding openings therein, wherein the second set of posts are set apart less than the first set of posts in order to fit within the first set of posts;
a top heating plate affixed to an underside of the cover;
a cylindrical shaft fixed through the openings of the first and second pairs of posts, wherein the cover and affixed heating plate are rotatable about the shaft;
a bottom ring having at least one tab extending from the rear of the ring, the tab having a slot that removably couples to the shaft;
a top ring having at least one tab extending from the rear of the ring, the tab having a slot that removably couples to the shaft; and
a cooking plate removably coupled to an underside of the top ring.

18. The food heating appliance of claim 17, wherein the cylindrical shaft has a diameter and a flat portion formed as a recess on a central portion of the shaft, the flat portion being narrower in width than the diameter of the shaft, wherein the top ring and the bottom ring are removably coupled to the shaft at its flat portion.

19. The food heating appliance of claim 17, further comprising:
a second tab extending from a side of the top ring;
a third tab extending from a side of the cooking plate in correspondence with the second tab extending from the side of the top ring; and
a fastener coupling the third tab on the cooking plate with the second tab on the top ring.

20. The food heating appliance of claim 19, the fastener further comprising:
a connection shaft having a head and a neck, the neck having a smaller diameter than the head and a set of internal threads formed inside the neck;
a spring fitted over the neck of the connection shaft to abut the head of the connection shaft; and
a locating pin having a head and a neck, the neck having a set of external threads that mate with the internal threads of the connection shaft;
wherein the connection shaft and spring are inserted from below through a first connection hole of the second tab of the top ring, and the threads of the locating pin are coupled with the threads of the connection shaft, and
wherein the connection shaft is pushed upward against a force of the spring to expose the neck of the connection shaft above the second tab of the top ring, and a slot formed in the third tab of the cooking plate is slid onto the exposed neck, then the connection shaft is released and returned downward by the spring force so that the locating pin drops into a second connection hole located on the third tab of the cooking plate.
